(19) United States
(12) Patent Application Publication
(10) Pub. No.: US 2002/0030488 A1
(43) Pub. Date: Mar. 14, 2002

(54) Method of detecting an absolute rotational position of a motor shaft

(76) Inventor: Yoshinori Ito, Nagano-ken (JP)

Correspondence Address: ROSENTHAL & OSHA L.L.P., 1221 MCKINNEY AVENUE, SUITE 2800, HOUSTON, TX, 77010, US

(21) Appl. No.: 09/912,924

(22) Filed: Jul. 25, 2001

(30) Foreign Application Priority Data
Jan. 25, 2000 (JP) P-2000-15441

(51) Int. Cl. G01B 7/30

(52) U.S. Cl. 324/207.25

(57) ABSTRACT

A method of detecting an absolute rotational position of a motor shaft uses an N-pole AC servo motor and a magnetic induction sensor affixed to the motor shaft. An inertial moment detection system that is used by the motor drive control to detect the position of magnetic poles is used to find N/2 magnetic base-points produced per motor revolution. From the magnetic induction sensor on the motor shaft, a detection signal is obtained having n cycles per motor revolution. The N/2 magnetic base-points are used as a basis for designating the number of each cycle of the detection signal output per motor revolution. This eliminates the need to use a plurality of sensors to achieve high detection resolution. Therefore, a high-resolution absolute sensor can be achieved without increasing the cost or size.

### BACKGROUND OF THE INVENTION

1. Field of the Invention

The present invention relates to a method of detecting an absolute rotational position of a motor shaft with a high resolution, using a magnetic induction type sensor.

2. Description of the Prior Art

Magnetic induction type sensors include those disclosed by, for example, JP-A 9-53909, JP-A 59-28603 and JP-A 55-46862. These sensors can detect an absolute rotational angle position within one sensor output signal wave period. The principle on which this is based is that of detecting the angle based on the phase differential between a phase signal composed of two phase sensor output signals and a sensor excitation signal. The position detection resolution within one signal period depends on the resolution of the signal detection circuit.

If, for example, the signal detection circuit is assumed to have a resolution of 12 bits, a magnetic induction sensor that outputs a one-cycle signal for one revolution of the target shaft (hereinafter referred to as a “1X sensor”) can detect an absolute angular position within one shaft revolution, and therefore can be used to realize a 12-bit absolute sensor. The resolution of the sensor can be enhanced by increasing the detection signal cycles output by the sensor per shaft revolution.

For example, a detection signal output of 16 cycles per shaft resolution would result in a resolution of 12 bits multiplied by 16 (2 to the power of 4), meaning 16 bits. If, however, the resolution is thus increased, it becomes impossible to detect the absolute rotational position because it is not possible to designate a particular one from among the 16 cycles output by the sensor per shaft revolution.

In order to enhance the absolute sensor resolution, a method is employed that uses a combination of a plurality of sensors. Examples include a combination of 1X and multipolar sensors, and a combination of n pole and (n+1) pole multipolar sensors. Prior art methods such as these require at least two sensors and a signal detection circuit for each circuit, increasing the cost and size.

### SUMMARY OF THE INVENTION

Considering the conventional problems, a main object of the present invention is to provide a method of detecting an absolute rotational position of a motor shaft with high resolution, without increasing the cost or size of an apparatus used to implement the method.

This invention focuses on an inertial moment detection system, which is one method of detecting the position of a magnetic pole in an AC servo motor, and combines a base-point magnetic pole detected by means of the system with a detection signal emitted by a magnetic induction type sensor to enable an absolute rotational position to be detected with high resolution.

Namely, the present invention provides a method of detecting an absolute rotational position of a motor shaft, comprising: setting a number of poles N of an AC servo motor (where N is a positive even number) and a number of cycles n per shaft revolution in a signal output by a magnetic induction type sensor affixed to the AC servo motor shaft (where n is an integer of 2 or more) to satisfy a relationship a(N/2) ≠bn (where a and b are integers); using an inertial moment detection system to find (N/2) base-point magnetic poles that appear per revolution of the AC servo motor; designating each of n cycles of a detection signal waveform obtained from the magnetic induction type sensor that appear per shaft revolution, based on the (N/2) base-point magnetic poles; and using the magnetic induction type sensor detection signal as a basis for detecting the absolute rotational position of the shaft.

### BRIEF DESCRIPTION OF THE DRAWINGS

FIG. 1 is an explanatory drawing of an AC servo motor system that can be used to apply the method of the invention.

FIG. 2 is a signal waveform showing the relationship between the excitation base-point of the AC servo motor and the detection signal of a 3X sensor.

FIG. 3 is a graph that illustrates the detection principle according to the absolute position detection method of the invention.

### DESCRIPTION OF THE PREFERRED EMBODIMENT

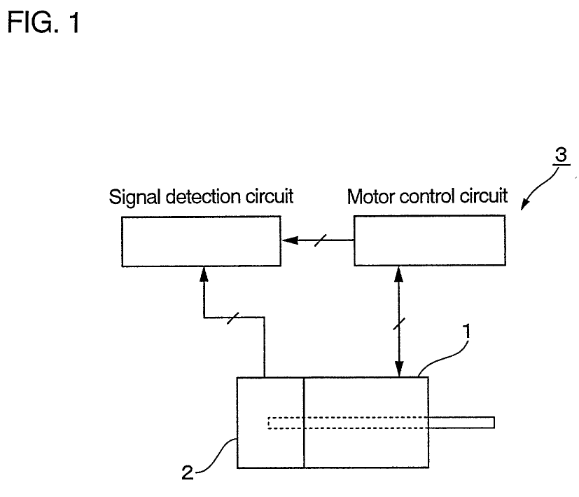

The method of detecting an absolute rotational position of a motor shaft of this invention is described below, with reference to FIGS. 1 to 3.

In an AC servo motor, the position of the magnetic poles has to be detected in order to synchronize the rotor magnetic poles with the rotational excitation field. Usually a magnetic pole sensor termed a CS sensor is provided for this purpose. However, it is known that by using an inertial moment detection system, the magnetic pole position can be detected without using a magnetic pole sensor. With this system, a current is passed through the motor coil, generating a rotational torque that is used to detect the rotational position of the rotor. The use of this system enables excitation base-points to be detected. The presence of the excitation base-points corresponds to the number of motor poles, and in combination with the magnetic induction type sensor enables an absolute rotational position to be detected.

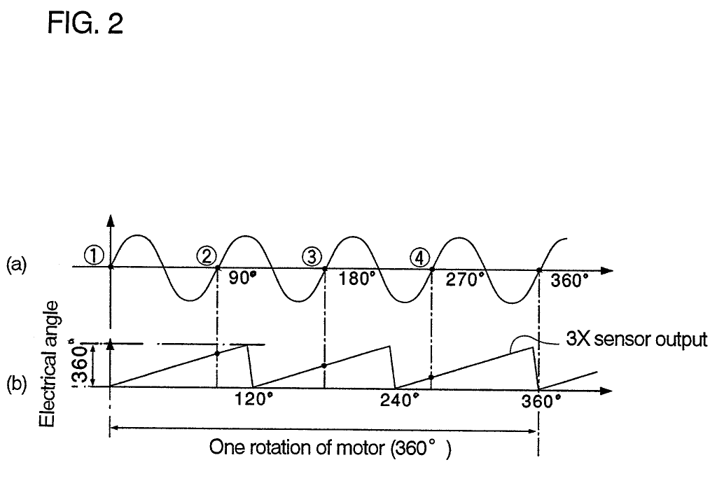

As an example, the detection principle will now be explained with reference to the example of the AC servo motor system 3 shown in FIG. 1 comprising an 8-pole AC servo motor 1 and a 3X sensor 2 (a magnetic induction sensor that provides three detection signal cycles per shaft revolution). As shown by FIG. 2(a), for each revolution of the rotor, a motor coil excitation base-point appears four times. As shown by FIG. 2(b), for each revolution of the rotor, the 3X sensor outputs three detection signal cycles, so it is possible to detect an absolute rotational angle position within the machine angle of 120 degrees.

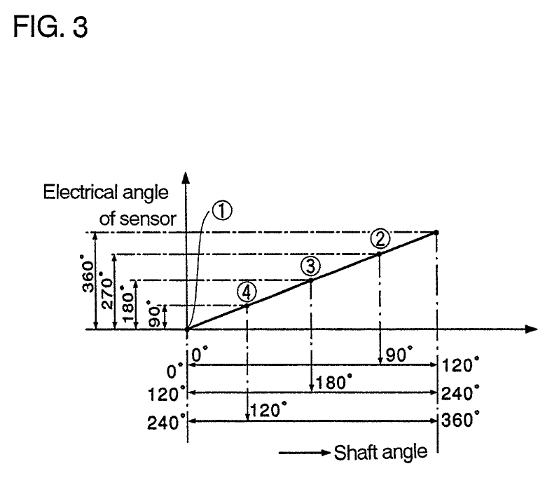

Thus, as shown by FIG. 3, it is possible to designate the position of the excitation base-points 1, 2, 3, 4 as viewed from the 3X sensor side. That is, it is possible to identify the number of each of the three cycles of the detection signal waveform output per shaft rotation. Therefore, by utilizing the excitation base-points, it is possible to achieve a high-resolution absolute sensor using just a magnetic induction sensor. The method of the invention can be applied when a(N/2) ≠bn (where a and b are integers), where N is the number of poles of the AC servo motor and n is the number of sensor signal cycles per shaft revolution.

As described in the foregoing, in the method of detecting an absolute rotational position of a motor shaft according to this invention, by using the excitation base-points detected using an AC servo motor inertial moment detection system, the absolute rotational position of the motor shaft can be detected with high resolution using just a magnetic induction sensor that produces multi-cycle detection signals per motor revolution. Thus, it is possible to achieve a high-resolution absolute position sensor without increasing the cost or size.

What is claimed is:

1. A method of detecting an absolute rotational position of a motor shaft, comprising: setting a number of poles N of an AC servo motor (where N is a positive even number) and a number of cycles n per shaft revolution in a signal output by a magnetic induction type sensor affixed to the AC servo motor shaft (where n is an integer of 2 or more) to satisfy a relationship a(N/2) ≠bn (where a and b are integers);
using an inertial moment detection system to find (N/2) base-point magnetic poles that appear per revolution of the AC servo motor;
designating each of n cycles of a detection signal waveform obtained from the magnetic induction type sensor that appear per shaft revolution, based on the (N/2) base-point magnetic poles; and
using the magnetic induction type sensor detection signal as a basis for detecting the absolute rotational position of the shaft.
